(19) United States
(12) Patent Application Publication
(10) Pub. No.: US 2026/0205863 A1
(43) Pub. Date: Jul. 16, 2026

(54) DEPLOYING CONGESTION MANAGEMENT ON DEMAND

(71) Applicant: T-Mobile Innovations LLC, Overland Park, KS (US)

(72) Inventors: Mochamad MIRZA, Bothell, WA (US); Kinneth Edmon BOUKNIGHT, Kirkland, WA (US); Liezel REOGANIS, Redmond, WA (US)

(21) Appl. No.: 19/023,931

(22) Filed: Jan. 16, 2025

(51) Int. Cl. H04W 28/02; H04L 47/24

(52) U.S. Cl. CPC H04W 28/0231; H04L 47/24

(57) ABSTRACT

Methods and systems provided herein include providing low loss, low latency, scalable (L4S) congestion management on demand for particular applications. L4S may be provided by subscription for a limited time for the particular applications, while other applications continue to use non-L4S congestion management methods.

### TECHNICAL BACKGROUND

As wireless networks evolve and grow, challenges arise in providing satisfactory congestion management solutions and quality of service (QoS) solutions for all network users. Typically, a wireless network utilizes a set of rules to prioritize traffic within a network. The network prioritizes and provides maximum speeds for some data, while slowing down other types of data or devices. For example, the network settings may prioritize high-demand activities like online gaming and video, particular augmented reality (AR) and virtual reality (VR) while slowing down traditional website performance.

For applications requiring low latency, a congestion control mechanism called low latency low loss scalable throughput (L4S) has evolved and is typically utilized with a particular QoS. L4S provides high-fidelity congestion feedback from network bottlenecks to the applications being used. The process involves applications implementing a new congestion-control algorithm that can understand that feedback, adjust their sending rates with better precision, and fully utilize link capacity without causing latency and packet loss. Thus, L4S operates by adapting the application data rate which leads to dramatically reducing network latency, jitter and packet loss. L4S requires a shorter delay factor during queuing than non-L4S traffic and therefore cannot be combined with non-L4S traffic in the same QoS bearer.

QoS is configured and assigned based on an umbrella of attributes. Those attributes are used for traffic flows such as browsing, streaming, interactive and background applications without distinguishing between the required characteristics and priority of each application or activity. Typically, all flows belonging to the same PDU session receive the same QoS from the wireless device, the radio access network (RAN) and the core network. Accordingly, from a scheduling perspective, this process results in all applications being treated the same during a protocol data unit (PDU) session when it comes to scheduling, buffer status report (BSR) reporting and transportation of associated flows. In some cases, the identical treatment of all flows during a session causes low latency and/or high bandwidth (BW) applications to experience degraded performance.

### OVERVIEW

Exemplary embodiments provided herein include a method for providing low latency low loss scalable throughput (L4S) for a particular application. The method includes receiving a request for low latency, low loss and scalable throughput (L4S) on demand from a requesting application executed by a wireless device and providing L4S on demand for the requesting application by deploying an alternative bearer providing a different quality of service (QoS) for execution of the application on the wireless device than a QoS provided by a default bearer. The method further includes maintaining the default bearer for other activities performed by the wireless device and providing non-L4S congestion control for the other activities.

Further aspects include a system for providing L4S congestion management for an application executed by a wireless device. The system includes wireless communication components facilitating communication with wireless devices and a memory storing data and instructions. The system further includes a processor executing the stored instructions to perform multiple operations. The operations include providing L4S on demand for a requesting application by deploying an alternative bearer providing a different quality of service QoS than a default QoS for execution of the requesting application on a wireless device and maintaining the default bearer receiving the default QoS for other activities performed by the wireless device and providing non-L4S congestion control for the other activities.

In yet a further aspect, a method is provided including offering an L4S on demand service to an application executed by a wireless device. The method deploys an alternative bearer providing a different QoS than a default QoS for execution of the application on a wireless device and provides L4S congestion management for the application. The method further maintains a default bearer receiving the default QoS for other activities performed by the wireless device and providing non-L4S congestion control for the other activities.

Yet further aspects include an access node and non-transitory computer-readable medium for managing deployment of L4S on demand.

### BRIEF DESCRIPTION OF THE DRAWINGS

FIG. 1 depicts an exemplary environment for providing L4S on demand in accordance with an embodiment.

FIG. 2 depicts an exemplary congestion management system in accordance with an embodiment.

FIG. 3 depicts an exemplary access node in accordance with an embodiment.

FIG. 4 depicts a further exemplary environment for L4S on demand in accordance with an embodiment.

FIG. 5 depicts an exemplary environment for deploying L4S on demand in accordance with an embodiment.

FIG. 6 depicts an exemplary method for providing L4S on demand in accordance with an embodiment.

FIG. 7 depicts a further exemplary method for providing L4S on demand in accordance with an embodiment.

FIG. 8 depicts a further exemplary method for providing L4S on demand in accordance with an embodiment.

### DETAILED DESCRIPTION

Embodiments provided herein include a method and system deploying and utilizing low latency low loss scalable throughput (L4S) on demand. Traffic prioritization and congestion management are typically configured by wireless network providers or by applications or associated network nodes. Traditional prioritization and congestion management methods fail to address user needs as users increasingly utilize different applications and engage in different activities during a protocol data unit (PDU) session. Accordingly, embodiments provided herein allow for wireless devices to dynamically request L4S, which is a particular congestion management solution. In order to enable L4S on demand, systems and methods provided herein utilize quality on demand (QoD), which also enables adjustments to a default QoS. For example, in a fifth generation (5G) environment, systems and methods proposed herein utilize QoD to change both the 5G quality indicator (5QI) and the congestion management solution for the requesting application.

For example, if a wireless device user is executing a virtual reality (VR) or augmented reality (AR) application on a VR or AR device tethered to the WiFi of the wireless device and wants to use the L4S congestion management solution, the user will be offered an option to subscribe. Upon deployment of the subscription option, the system disclosed herein changes the 5QI for tethering and stops utilizing the default 5QI. In examples provided herein, the system changes the 5QI for tethering from 5QI-8 to 5QI-80 for the requesting application. However, any remaining applications tethered to WiFi will continue to utilize 5QI-8, which is the default 5QI in this instance, and non L4S congestion management. Only the traffic from the requesting VR or AR application will receive the benefit of L4S congestion management.

Accordingly, in embodiments provided herein, applications requiring lower latency can receive the benefit of L4S, while other applications not requiring this performance will continue to be treated according to default 5QI and non-L4S settings. While it is desirable for applications to move to L4S due to the lower latency, it is not possible to mix L4S and non-L4S traffic using the same 5QI bearer. This is due to the fact that in operation, the access node supporting L4S marks congestion experienced (CE) packets at early signs of congestion. CE marking starts when the queue is higher than a defined threshold, which can be based on marking probability. However, the queue delay target differs between L4S and classic mobile broadband (MBB) traffic, L4S-capable network nodes (require an additional queue using a lower delay threshold. In addition to queue delay, the channel quality indicator (CQI) is used to estimate the radio interface capacity, giving a more proactive reaction to congestion. Thus, the use of L4S is desirable embodiments disclosed herein enable the use of L4S on demand.

In embodiments provided herein, the L4S on demand is provided as a subscription service. The subscription may be provided on demand or alternatively, the subscription may be active during certain hours or active for a predetermined time duration for one or more specific applications.

Further, in embodiments provided herein, an AR or VR device may be tethered to WiFi of another wireless device. Thus, the QoS for the AR or VR devices tethering to WiFi is changed from the QoS provided by the default bearer to the different QoS for the requesting application.

In embodiments described herein, a new radio bearer may be deployed and will be maintained for a predetermined time period for use by the application requesting L4S. In embodiments provided herein, the bearer may be used for the identified flows throughout a PDU session and then will be de-configured when the PDU session terminates. Alternatively, the bearer may be terminated prior to the termination of the PDU session. Termination of the bearer when the predetermined time period lapses, when the subscription is expired, or when the application is no longer in use is performed to free up resources on the RAN and core network.

Systems and methods described herein improve upon the current configuration in which all flows belonging to the same PDU session get the same priority, congestion management, and the same traffic prioritization. While currently, only one radio bearer is typically provided for a PDU session, embodiments provided herein provide more than one bearer per PDU session.

An exemplary environment described herein includes at least an access node (or base station), such as a next generation NodeB (gNodeB), and at least one end-user wireless device. For illustrative purposes and simplicity, the disclosed technology will be illustrated and discussed as being implemented in the communications between an access node (e.g., a base station) and a wireless device (e.g., an end-user wireless device). In addition to the systems and methods described herein, the operations for providing L4S on demand may be implemented as computer-readable instructions or methods.

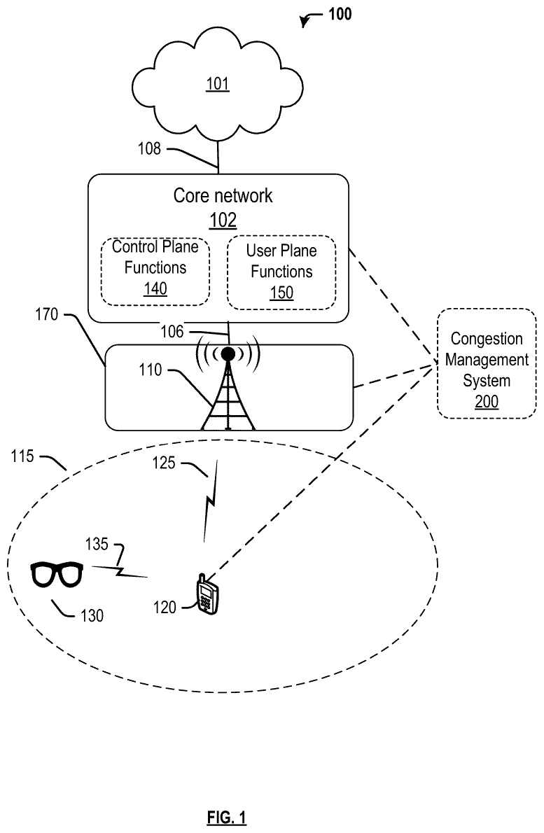

FIG. 1 depicts an exemplary environment 100 for implementing a congestion management system 200 providing L4S on demand in a wireless network. In the displayed environment 100, a congestion management system 200 operates to process L4S subscriptions and provide L4S on demand to requesting applications executing on wireless devices 120, 130 within a coverage area 115. The wireless device 120 may be, for example, an enhanced mobile broadband (eMBB) device or any other type of wireless device capable of connecting with a wireless network. The wireless device 130 may be or include, for example, an AR or VR device that can be tethered to WiFi provided by the wireless device 120.

Environment 100 comprises a communication network 101, core network 102, and a radio access network (RAN) 170 including at least an access node 110. Wireless device 120 communicates with the access node 110 via a wireless link 125 and the AR/VR wireless device 130 may communicate with the wireless device 120 via the wireless link 135. The congestion management system 200 operates to enable the wireless device 120 and/or the AR/VR wireless device 130 to request L4S from the access node 110 for a particular activity or application.

Additionally, components not shown may include, for example, gateway node(s) controller nodes, and additional access nodes. For example, a wireless network may include one or more access nodes, such as base stations including evolved NodeBs (eNBs) or next generation NodeBs (gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 6G or 4G long-term evolution (LTE) access nodes.

Access node 110 can be any network node configured to provide communication between end-user wireless devices 120, 130 and communication network 101, including standard access nodes and/or short range, low power, small access nodes. For instance, access node 110 may include any standard access node, such as a macrocell access node, base transceiver station, a radio base station, an eNodeB device, an enhanced eNodeB device, a next generation NodeB device (gNBs) in 5G networks, or the like.

Further the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 120 are illustrated in FIG. 1, any number of access nodes and wireless devices can be implemented within environment 100.

The exemplary operating environment 100 may further include the congestion management system 200, which is illustrated as operating in conjunction with the wireless devices 120, 130, the access node 110, and the core network 102. In embodiments described herein, the congestion management system 200 is incorporated in the RAN 170, but may also be distributed and include components at the access node 110 cooperating with the components of the wireless devices 120, 130.

The congestion management system 200 enrolls applications for L4S on demand and monitors activities performed on the wireless devices 120, 130 to ensure that L4S on demand is provided for the enrolled applications during an enrolled time period. The congestion management system 200 may further trigger deployment of a bearer having a 5QI different from a default 5QI of an existing bearer provided by the access node 110. After the enrolled time period expires, the congestion management system 200 may trigger termination of the bearer having the different 5QI and providing L4S and the default configuration may be restored.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 is capable of communicating with the core network 102 as well as various additional nodes including gateway nodes, controller nodes, and other access nodes.

Further, the access node 110 may communicate with the congestion management system 200 and may partially incorporate the congestion management system 200. Thus, the congestion management system 200 may collect data based on a subscription of the wireless device 120, 130 and may perform processing in order to trigger a request for a dedicated bearer having a target QoS different from the default QoS. The dedicated bearer may further be utilized to provide L4S congestion management to the wireless devices 120, 130.

Wireless device 120 may be any device, system, combination of devices, or other such communication platform capable of communicating wirelessly with access node 110 using one or more frequency bands deployed therefrom. For example, the wireless device 120 may be, for example, an eMBB device. The wireless device 120 may be or include, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. Further, the wireless device 130 may be or include a VR or AR device.

The core network 102 includes core network functions and elements. The core network may be structured using a service-based architecture (SBA). The network functions and elements may be separated into user plane functions 150 and control plane functions 140. In an SBA architecture, service-based interfaces may be utilized between control-plane functions, while user-plane functions connect over point-to-point link. The user plane functions (UPF) 150 access a data network, such as network 101, and perform operations such as packet routing and forwarding, packet inspection, policy enforcement for the user plane, quality of service (QoS) handling, etc. The control plane functions 140 may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless device 120 and is responsible for handling connection and mobility management tasks. The SMF is primarily responsible for creating, updating, and removing sessions and managing session context. The UDM function provides services to other core functions, such as the AMF, SMF, and NEF. The UDM function may provide a stateful message store, holding information in local memory. The NSSF can be used by the AMF to assist with the selection of network slice instances that will serve a particular device. Further, the NEF provides a mechanism for securely exposing services and features of the core network.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device. Wireless network protocols can comprise multimedia broadcast multicast service (MBMS), code division multiple access (CDMA), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path, including combinations thereof. Communication links 106 and 108 can be wired or wireless and use various communication protocols such as Internet, Internet protocol (IP), local-area network (LAN), optical networking, hybrid fiber coax (HFC), telephony, T1, or some other communication format. Communication links 106 and 108 can be a direct link or might include various equipment, intermediate components, systems, and networks. Communication links 106 and 108 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

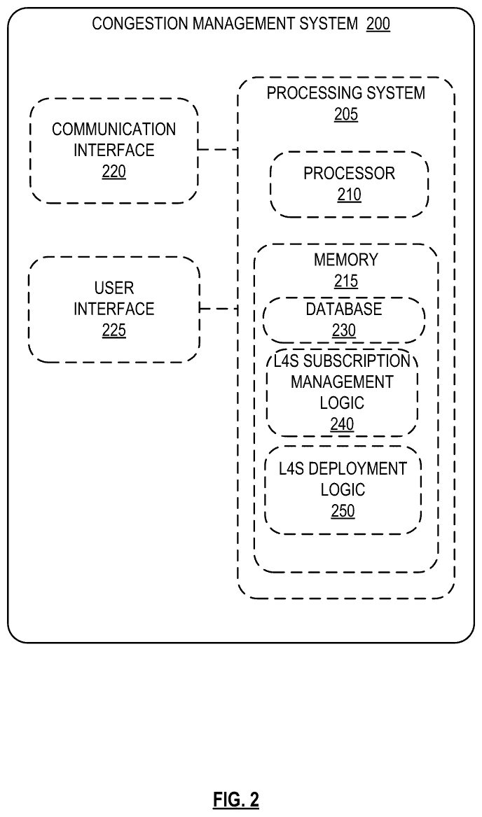

FIG. 2 illustrates a congestion management system 200 in accordance with embodiments described herein. The components described herein are merely exemplary as many different configurations for the congestion management system 200 may be implemented. The congestion management system 200 may be configured to perform the methods and operations disclosed herein to dynamically trigger deployment of a bearer for enabling L4S on demand for a limited predetermined time period.

Thus, the congestion management system 200 may communicate with the access node 110 and additionally or alternatively the wireless devices 120, 130 to determine which applications receive L4S and when the applications receive L4S. The congestion management system 200 may evaluate the gathered information to trigger deployment of a bearer having a QoS different from the QoS of a default bearer, wherein the newly deployed bearer further enables L4S for the predetermined limited time period. In the disclosed embodiments, the congestion management system 200 may be integrated with the access node 110, or may be an entirely separate component capable of communicating with the access node 110 and/or wireless devices 120, 130. Further, the components of the congestion management system 200 may be distributed so that one or more components are located within the RAN 170, and/or a separate processing node in communication with the RAN 170.

The congestion management system 200 may be configured for performing the operations described herein utilizing a processing system 205. Processing system 205 may include a processor 210 and a memory 215. The memory 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in memory 215 may include computer programs, firmware, or other form of machine-readable instructions, including an operating system, utilities, drivers, network interfaces, applications, or other type of software. For example, software stored in memory 215 may include a module for performing various operations described herein.

For example, L4S subscription management logic 240 may enable enrollment by the wireless devices 120, 130. Wireless devices 120, 130 may be invited to enroll or subscribe to L4S congestion management upon activation of certain applications. Alternatively, wireless device users may proactively request a subscription for particular activities or applications performed by the wireless devices 120, 130. Wireless device users may select a predetermined time period for a subscription duration or multiple predetermined time periods in which the subscription will be valid. The L4S subscription management logic 240 may store the subscriptions in a database 230.

L4S deployment logic 250 may monitor L4S subscriptions managed by the L4S subscription management logic 240. Further, the L4S deployment logic 250 may obtain subscription information from the database 230. The L4S deployment logic 250 may trigger deployment of a radio bearer having a QoS different from a default radio bearer upon detecting an active L4S subscription for a currently executed application. For example, the L4S deployment logic 250 may trigger deployment of a 5QI-80 radio bearer in addition to providing a 5QI-8 radio bearer for applications not subscribed to L4S. Thus, applications subscribed to L4S will communicate over the newly deployed radio bearer for a limited time period and will be entitled to L4S congestion management during that time period. The L4S deployment logic 250 may further monitor for the expiration of the predetermined time period and disable the newly deployed radio bearer upon expiration of the predetermined time period.

Further, the memory 215 may include the database 230. The database 230 may store network information, L4S subscriptions, applications subscribing, predetermined time periods for deploying a radio bearer and providing L4S, and other information. To perform the above-described operations, the L4S subscription management logic 240 and the L4S deployment logic 250 may be executed by the processor 210 to manage the provision of L4S for wireless devices 120, 130.

Processor 210 may be a microprocessor and may include hardware circuitry and/or embedded codes configured to retrieve and execute software stored in the memory 215. The congestion management system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the congestion management system 200 and receive data or information from other system components. User interface 225 may include hardware components, such as touch screens, buttons, displays, speakers, etc. The congestion management system 200 may further include other components such as a power management unit, a control interface unit, etc.

Accordingly, the congestion management system 200 executes instructions stored in memory 215 to determine when deployment of a bearer having a QoS different from a default QoS should be triggered. Further, the congestion management system 200 determines which applications can utilize the newly deployed bearer and L4S and when these applications can utilize the newly deployed bearer with L4S congestion management.

The location of the congestion management system 200 may depend upon the network architecture. As set forth above, the congestion management system 200 may be located in the RAN 170, in a separate processing node, or in multiple locations. Further, although shown as a single integrated system, the functions described herein may be separated and be disposed in separate locations.

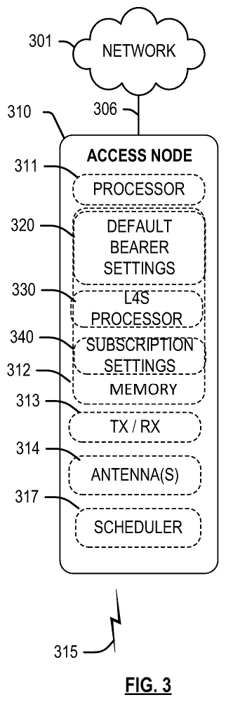

FIG. 3 depicts an exemplary access node 310. The access node 310 may be a more specific rendering of the access node 110. Access node 310 is configured as an access point for providing network services from network 301 to end-user wireless devices such as wireless devices 120, 130. Access node 310 is illustrated as comprising a memory 312 for storing logical modules that perform operations described herein, a processor 311 for executing the logical modules, and a transceiver 313 for transmitting and receiving signals via one or more antennas 314. Combinations of antennas 314 and transceivers 313 are configured to deploy wireless air interfaces and therefore function as wireless communication components. Further, the different sets of antennas can be used to implement various transmission modes or operating modes in each sector, including but not limited to multiple in multiple out (MIMO), carrier aggregations, and different duplexing modes including frequency division duplexing (FDD) and time division duplexing (TDD). Further, access node 310 deploys different bearers for communication with the wireless devices 120, 130 wherein the different bearers have different characteristics. For example, different bearers provide different QoS. Also, some bearers may provide L4S congestion management and others may not. The access node 310 is communicatively coupled to network 301 via communication interface 306, which may be any wired or wireless link as described above. Scheduler 317 may be provided for scheduling resources for the wireless device 120, 130. Wireless communication link 315 may facilitate communication with the wireless devices 120, 130 in both uplink and downlink directions.

In an exemplary embodiment, memory 312 includes default bearer settings 320 as well as an L4S processor 330. The default bearer settings 320 represent default settings for bearers generally deployed for communication with the wireless devices 120, 130. The L4S processor 330 may trigger deployment of a new bearer upon detection of activity from an application having an L4S subscription. For example, when the congestion management system 200 determines that an application is entitled to L4S congestion management, and the L4S processor 330 triggers deployment of the new bearer. Applications communicating through the newly deployed bearer receive the benefit of L4S congestion management. Subscribing applications may require lower latency than the latency provided by a default bearer.

In some embodiments, the congestion management system 200 may be wholly or partially incorporated in the access node 310. In other embodiments, the congestion management system 200 may operate cooperatively with the access node 310 in order to deploy a new bearer having a QoS different from a default QoS in order to provide L4S congestion management to subscribing applications requiring low latency.

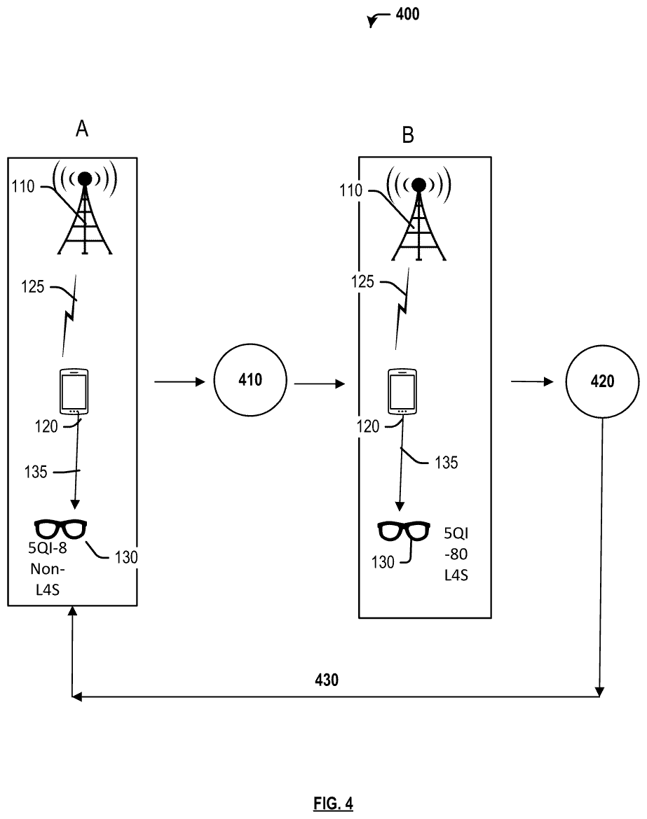

FIG. 4 depicts a further exemplary environment 400 for providing L4S by subscription in accordance with an embodiment. More specifically, FIG. 4 illustrates an environment for providing a subscription for L4S congestion management to wireless devices 120 and 130, where the wireless device 130 is tethered to the WiFi of the wireless device 120 via the communications link 135. Further, the illustrated access node 110 communicates over wireless link 125. The aforementioned components may be the same as or substantially similar to those described above with respect to FIG. 1.

Scenario A illustrates a default scenario in which the wireless device 130 utilizes a default bearer having a QoS of 5QI-8. This default bearer having the QoS of 5QI-8 is not capable of providing L4S congestion management. However, the wireless device 130 is an AR/VR device and requires a low latency. Accordingly, at 410, the wireless device 130 triggers a request through the wireless device 120 to utilize quality on demand (QoD) and request L4S congestion management for a set period of time. The set period of time may be determined by the requesting user of the wireless devices 130, 120 or by the network. For example, the network may provide a menu of selectable durations along with applicable prices for each selection for providing L4S for the selected duration.

As a result of the request at 410, scenario B occurs. In scenario B, the access node 110 deploys a new bearer different from the default 5QI-8 bearer. The new bearer in this instance provides a QoS of 5QI-80 and further provides L4S congestion management for the AR/VR applications deployed by the requestor using wireless devices 120, 130. The L4S congestion management ensures a low latency for the requesting VR/AR application.

After the set period of time expires, in step 420, the wireless devices 120, 130 revert back to scenario A from scenario B at 430. Accordingly, all applications utilized by the wireless devices 120, 130 utilize the original default bearer, which in this example is a 5QI-8 bearer that does not provide L4S congestion management.

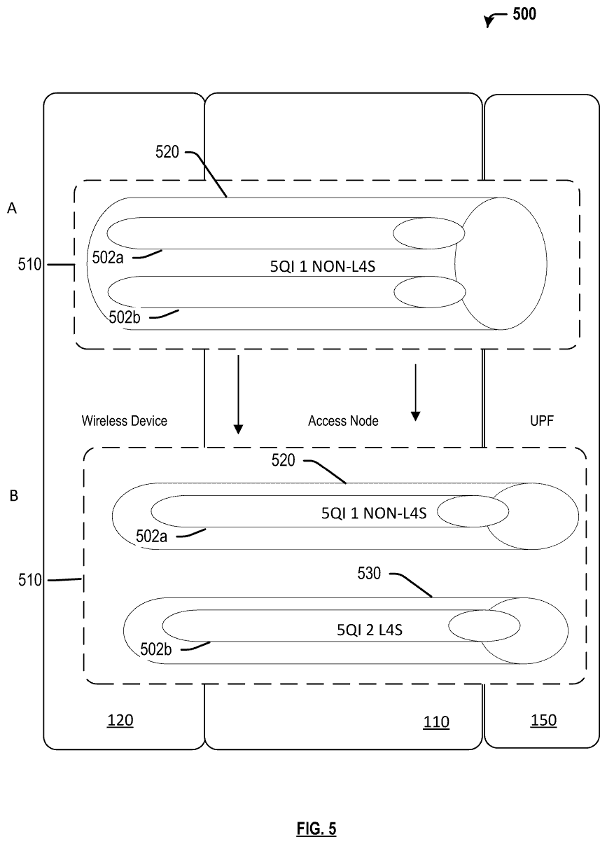

FIG. 5 depicts a further exemplary environment 500 for providing congestion management including L4S on demand accordance with an embodiment. More specifically, FIG. 5 illustrates a PDU session 510. The core network 102 establishes the PDU session 510 for the wireless device 120. As illustrated in Part A of FIG. 5, the PDU session 510 may be established with a single bearer 520 labeled as 5QI1 non-L4S. However, the single bearer 520 may include multiple data flows 502a and 502b due to multiple applications or activities utilized by the wireless device 120. For example, the data flow 502a may be a browsing data flow that does not require a low latency and the data flow 502b may be a VR gaming data flow that does require a low latency. While the data flows 502a and 502b may be classified and marked using a QoS flow identifier (QFI), they receive the same QoS and default congestion management (non-L4S) when utilizing the same bearer 520.

However, as illustrated in Part B of FIG. 5, when the congestion management system 200 operates to trigger deployment of a dedicated bearer based and L4S congestion management due to the request of an application running on the wireless device 120 that has a low latency requirement, the configuration may be altered to include an additional bearer 530 for the data flow 502b. For example, the congestion management system 200 may find that the data flow 502a is a browsing session, but that the data flow 502b is a VR gaming application. Because the gaming application requires a higher QoS and lower latency than the browsing session, the congestion management system 200 may trigger a request to the access node 110 and or core network 102 for a dedicated bearer having a different QoS and a capability for L4S congestion management. In this case, the access node 110 may deploy the dedicated bearer 530, labeled as 5QI2 L4S, for the VR gaming data flow 502b within the PDU session 510 resulting in the configuration shown in Part B.

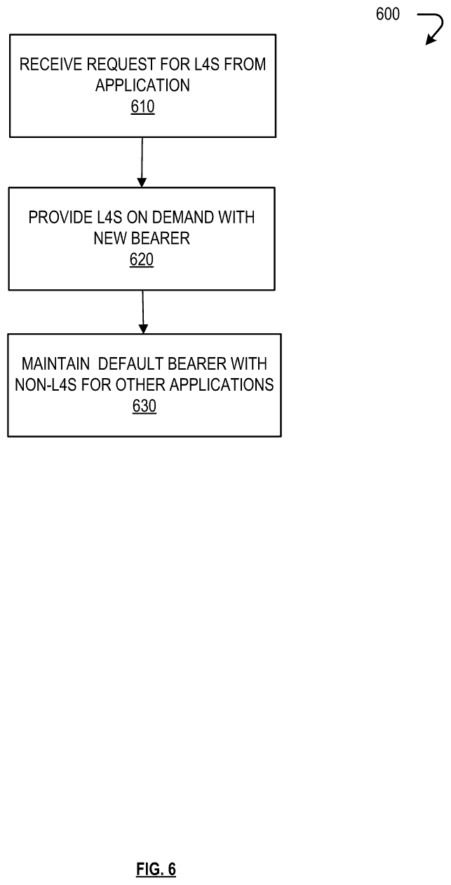

FIG. 6 illustrates an exemplary method 600 for operation of the congestion management system 200. Method 600 may be performed by any suitable processor discussed herein, for example, the processor 210 included in the congestion management system 200. For discussion purposes, as an example, method 600 is described as being performed by the processor 210 included in the congestion management system 200.

Method 600 starts in step 610, in which the processor 210 receives a request for L4S congestion management from an application. As set forth above, the application may be an AR or VR gaming application. However, the application may alternatively be a voice application, streaming video, file transfer applications, or other application that requires low latency. The applications may further be or include guaranteed bit rate (GBR) applications. In some embodiments, multiple applications executed on a wireless device may request L4S simultaneously.

In step 620, the processor 210 deploys a new radio bearer having a different QoS than the default radio bearer so that L4S congestion management can be provided through the new radio bearer. For example, the default radio bearer may have a QoS of 5QI-8, whereas the newly deployed radio bearer may have a QoS of 5QI-80. The default radio bearer may not provide L4S congestion management, whereas the newly deployed bearer provides L4S congestion management. The different levels of QoS may include, for example, be represented by different quality class identifiers (QCI) or 5G quality of service identifiers (5QI). QCIs and 5QIs are generally allocated by network service providers by default. QCI and 5QI values are based on requirements including latency, packet loss, and reliability.

In step 630, the default radio bearer is maintained with non-L4S congestion management for applications not requesting L4S. Accordingly, both the default radio bearer and the newly deployed radio bearer may be simultaneously active to provide an appropriate congestion management approach for all different types of data flows. In embodiments provided herein, the processor 210 may utilize the newly deployed radio bearer in both uplink and downlink directions.

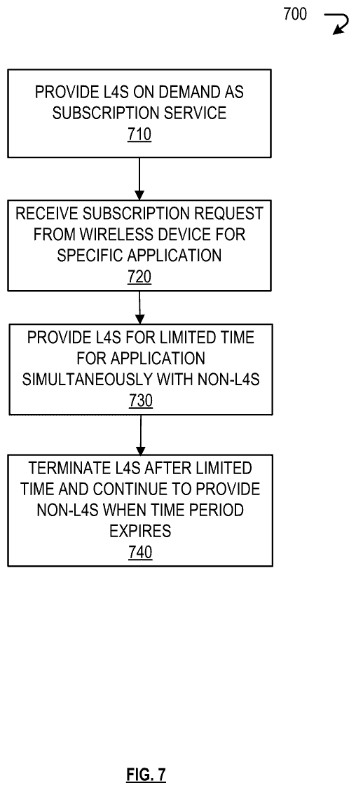

FIG. 7 illustrates an exemplary method 700 for operation of the congestion management system 200. Method 700 may be performed by any suitable processor discussed herein, for example, the processor 210 included in the congestion management system 200. For discussion purposes, as an example, method 700 is described as being performed by the processor 210 included in the congestion management system 200.

Method 700 starts in step 710, in which the processor 210 provides L4S on demand as a subscription service. For example, the processor 210 may provide L4S for a limited predetermined time period by providing a menu of options including different predetermined time periods for L4S congestion management. The predetermined time period may include specific hours and days or may include the duration of a specific number of PDU sessions. Optionally, the predetermined time period may include a full week or month. Other time periods are within scope of the disclosure.

The method continues in step 720, in which the processor 210 receives a subscription request from a wireless device for L4S congestion management for a specific application. It should be noted that the specific application may include one or more applications executed on a wireless device that are requesting L4S congestion management. The applications may be or include, for example, applications requiring low latency or a guaranteed bit rate.

In response to the request received in step 720, the processor 210 provides L4S for a limited time in step 730 for the requesting application or application. The L4S may be provided simultaneously with non-L4S, for example, by deploying an additional data radio bearer with a different QoS from the default QoS as further described herein.

Finally, in step 740, the processor 210 terminates L4S after the predetermined limited time defined by the subscription. Upon termination of L4S, all applications utilize the default radio bearer and receive non-L4S treatment.

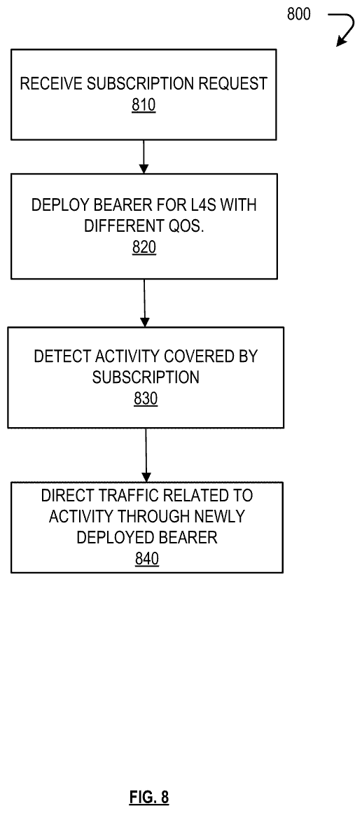

FIG. 8 illustrates an exemplary method 800 for operation of the congestion management system 200. Method 800 may be performed by any suitable processor discussed herein, for example, the processor 210 included in the congestion management system 200. For discussion purposes, as an example, method 800 is described as being performed by the processor 210 included in the congestion management system 200.

Method 800 starts in step 810, in which the processor 210 receives a subscription request for L4S from one or more applications. The applications may be or include, for example, applications requiring low latency and/or a guaranteed bit rate (GBR) requirements.

In step 820, the processor 210 may trigger deployment of a radio bearer for L4S that has a different QoS than the provided default radio bearer. For example, the processor 210 may trigger a request for a dedicated bearer from the RAN 170 with the different QoS and the capability for L4S congestion management. In step 830, the processor 210 monitors activity and detects activity covered by the subscription initiated by the subscription request. Finally, in step 840, the processor 210 directs traffic related to the activity through the newly deployed bearer that provides L4S congestion management

In some embodiments, methods 600, 700, and 800 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 600, 700, and 800 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
receiving a request for low latency, low loss and scalable throughput (L4S) on demand from a requesting application executed by a wireless device;
providing L4S on demand for the requesting application by deploying an alternative bearer providing a different quality of service (QoS) for execution of the application on the wireless device than a QoS provided by a default bearer; and
maintaining the default bearer for other activities performed by the wireless device and providing non-L4S congestion control for the other activities.

2. The method of claim 1, further comprising offering the L4S on demand as a subscription service.

3. The method of claim 1, wherein the requesting application is an augmented reality (AR) or virtual reality (VR) application.

4. The method of claim 1, wherein the wireless device is tethered to WiFi and the QoS for tethering to WiFi is changed from the QoS provided by the default bearer to the different QoS for the requesting application.

5. The method of claim 4, further comprising providing the different QoS and the L4S on demand service for a predetermined time period before returning to the QoS provided by the default bearer and non-L4S service for the requesting application.

6. The method of claim 1, wherein the QoS provided by the default bearer is fifth generation (5g) QoS identifier (5QI)-8.

7. The method of claim 6, wherein the different QoS is 5QI-80.

8. A system comprising:
wireless communication components facilitating communication with wireless devices;
a memory storing data and instructions; and
a processor executing the stored instructions to perform operations including:
providing low latency, low loss, and scalable throughput (L4S) on-demand for a requesting application by deploying an alternative bearer providing a different quality of service (QoS) than a default QoS for execution of the requesting application on a wireless device; and
maintaining a default bearer receiving the default QoS for other activities performed by the wireless device and providing non-L4S congestion control for the other activities.

9. The system of claim 8, the operations further including receiving a request for the L4S on demand through the default bearer from a requesting application executed by the wireless device.

10. The system of claim 8, the operations further comprising offering the L4S on demand as a subscription service.

11. The system of claim 8, wherein the requesting application is an augmented reality (AR) or virtual reality (VR) application.

12. The system of claim 8, wherein the wireless device is tethered to WiFi and the quality of service for tethering to WiFi is changed from the default QoS to the different QoS for the requesting application.

13. The system of claim 8, the operations further comprising providing the different QoS and the L4S on demand service for a predetermined time period before returning to the default QoS and non-L4S service for the requesting application.

14. The system of claim 8, wherein the default QoS is fifth generation (5g) QoS identifier (5QI)-8 and the different QoS is 5QI-80.

15. A method comprising:
offering a low latency, low loss and scalable throughput (L4S) on demand service to an application executed by a wireless device;
providing L4S on demand for an application by deploying an alternative bearer providing a different quality of service (QoS) than a default QoS for execution of the application on a wireless device; and
maintaining a default bearer receiving the default QoS for other activities performed by the wireless device and providing non-L4S congestion control for the other activities.

16. The method of claim 15, further comprising offering the L4S on demand as a subscription service.

17. The method of claim 15, wherein the application is an augmented reality (AR) or virtual reality (VR) application.

18. The method of claim 15, wherein the wireless device is tethered to WiFi and the quality of service for tethering to WiFi is changed from the default QoS to the different QoS for the application.

19. The method of claim 18, further comprising providing the different QoS and the L4S on demand service for a predetermined time period before returning to the default QoS and non-L4S service for the application.

20. The method of claim 15, wherein the default QoS is fifth generation (5g) QoS identifier (5QI)-and the different QoS is 5QI-80.
